(19) United States
(12) Patent Application Publication
(10) Pub. No.: US 2012/0249885 A1
(43) Pub. Date: Oct. 4, 2012

(54) LIGHTING DEVICE, DISPLAY DEVICE AND TELEVISION RECEIVER

(75) Inventor: Mitsuru Hosoki, Osaka-shi (JP)

(73) Assignee: SHARP KABUSHIKI KAISHA, Osaka-shi, Osaka (JP)

(21) Appl. No.: 13/515,359

(22) PCT Filed: Nov. 17, 2010
(86) PCT No.: PCT/JP2010/070459

§ 371 Date: Jun. 12, 2012

(30) Foreign Application Priority Data
Dec. 23, 2009 (JP) 2009-291570

(51) Int. Cl. F21V 8/00; F21V 5/02; H04N 5/44; F21V 7/04

(52) U.S. Cl. 348/725; 362/611; 362/606; 362/607; 362/612; 362/602; 348/E05.096

(57) ABSTRACT

A lighting device configured to restrict uneven brightness is provided. A lighting device according to the present invention includes an LED 22 having a light emitting surface 22A, a light guide plate 50 arranged opposite to the light emitting surface 22A and having a light incident surface 50D into which light from the light emitting surface 22A makes incidence and a light exit surface 50A from which the light output, and an optical member 40 arranged to cover the light exit surface 50A. The optical member 40 has a light blocking portion 60 at an edge portion thereof on a side of the LED 22, which blocks light incident into the optical member 40 from side surfaces 41A to 43A of the optical member 40 on the side of the LED 22.

### TECHNICAL FIELD

The present invention relates to a lighting device, a display device and a television receiver.

### BACKGROUND ART

In recent years, a flat display element such as a liquid crystal panel or a plasma display panel is used as a display element of an image display device, which brings thinning of the image display device. In a case where the liquid crystal panel is used as the display element, a lighting device (backlight unit) is required separately since the liquid crystal panel is not self-emissive.

As an example, a lighting device described in the following Patent Document 1 is known. This lighting device has a light source (such as an LED) arranged at a side edge portion of the lighting device and a light guide plate guiding light from the light source to be output toward a display surface of a liquid crystal panel. The light source faces a light entrance surface of the light guide plate, and incidence of light from the light entrance surface is guided by repeating total reflection in the light guide plate, and is output from a light exit surface. Also known is a lighting device of arranging an optical member such as a light diffuser sheet and a prism sheet so as to cover the light exit surface of the light guide plate.

Patent Document 1: Japanese Unexamined Patent Publication No. 2007-293339

### Problem to be Solved by the Invention

In the aforementioned configuration of arranging the optical member so as to cover the light exit surface of the light guide plate, there is a case in which light output from the light source makes incidence from a side surface of the optical member on a side of the light source. When the light makes incidence from the side surface of the optical member on the side of light source, the light may repeat total reflection in the optical member and be guided to an inside of the lighting device. As a result, the light guided in the optical member may be locally output from the light exit surface of the lighting device to cause uneven brightness.

### DISCLOSURE OF THE PRESENT INVENTION

The present invention was made in view of the foregoing circumstances. An object of the present invention is to provide a lighting device configured to restrict uneven brightness. Another object of the present invention is to provide a display device including such a lighting device and a television receiver.

### Means for Solving the Problem

To solve the above problem, a lighting device according to the present invention includes a light source having a light emitting surface, a light guide plate opposite to the light emitting surface and having a light entrance surface through which light from the light emitting surface enters and a light exit surface from which the light output, and an optical member arranged to cover the light exit surface, the optical member having a light blocking portion at an edge portion thereof on alight source side and being configured to block light entering the optical member from a side surface of the optical member on the light source side.

In the present invention, the optical member has the light blocking portion at the edge portion thereof on the light source side, which blocks light incident into the optical member from the side surface of the optical member on the light source side. This configuration restricts a phenomenon in which the light from the light source makes incident into the optical member from the side surface of the optical member on the light source side and is guided into the optical member. This restricts a phenomenon in which guided light is output locally from the light exit surface of the lighting device, and thereby occurrence of uneven brightness.

In the above configuration, the lighting device may further include a housing member housing the light source, the light guide plate and the optical member. The light blocking portion may be formed by projecting a part of the housing member and may be arranged to cover the side surface of the optical member on the light source side. Forming the light blocking portion by projecting a part of the housing member dispenses with separate attachment of the light blocking portion and reduces cost for assembly.

The light blocking portion may be formed by applying paint having light blocking properties to the side surface of the optical member on the light source side. The configuration of forming the light blocking portion by applying the paint further reduces size of the light blocking portion and restricts size increase of the lighting device.

The light blocking portion may be formed by enclosing a light blocking member into the edge portion of the optical member on the light source side. The configuration of forming the light blocking portion by enclosing the light blocking member into the edge portion of the optical member on the light source side dispenses with separate attachment of the light blocking portion and reduces cost for assembly.

The light blocking portion may be a light absorbing portion configured to absorb light. The light blocking portion is configured to absorb light incident from the side surface on the light source side into the optical member, which restricts the incidence of the light incident into the optical member more reliably.

The light blocking portion may be a light reflecting portion configured to reflect light.

The optical member may include a light diffuser member.

The optical member may include a prism sheet.

The optical member may include a reflection-type polarizing sheet.

The light source may be a light emitting diode. Using the light emitting diode restricts power consumption.

Also, to solve the above problem, a display device according to the present invention includes the aforementioned lighting device and a display panel configured to provide display utilizing light from the lighting device.

The display panel may be a liquid crystal panel. Such a display device may be applied as a liquid crystal display device to various applications such as a television screen or a desktop screen of a personal computer, and is especially suitable for a large-sized screen.

Further, to solve the above problem, a television receiver according to the present invention includes the aforementioned display device.

### Advantageous Effect of the Invention

The present invention provides a lighting device configured to restrict uneven brightness, a display device including such a lighting device and a television receiver.

### BRIEF DESCRIPTION OF THE DRAWINGS

FIG. 1 is an exploded perspective view illustrating a schematic configuration of a television receiver according to a first embodiment of the present invention;

FIG. 2 is an exploded perspective view illustrating a schematic configuration of a liquid crystal display device included in the television receiver in FIG. 1;

FIG. 3 is a cross-sectional view illustrating a cross-sectional configuration along a shorter side direction of the liquid crystal display device in FIG. 2;

FIG. 4 is a cross-sectional view illustrating a comparative example;

FIG. 5 is a cross-sectional view illustrating a cross-sectional configuration along a shorter side direction of a liquid crystal display device according to a second embodiment of the present invention; and

FIG. 6 is a cross-sectional view illustrating a cross-sectional configuration along a shorter side direction of a liquid crystal display device according to a third embodiment of the present invention.

### BEST MODE FOR CARRYING OUT THE INVENTION

### First Embodiment

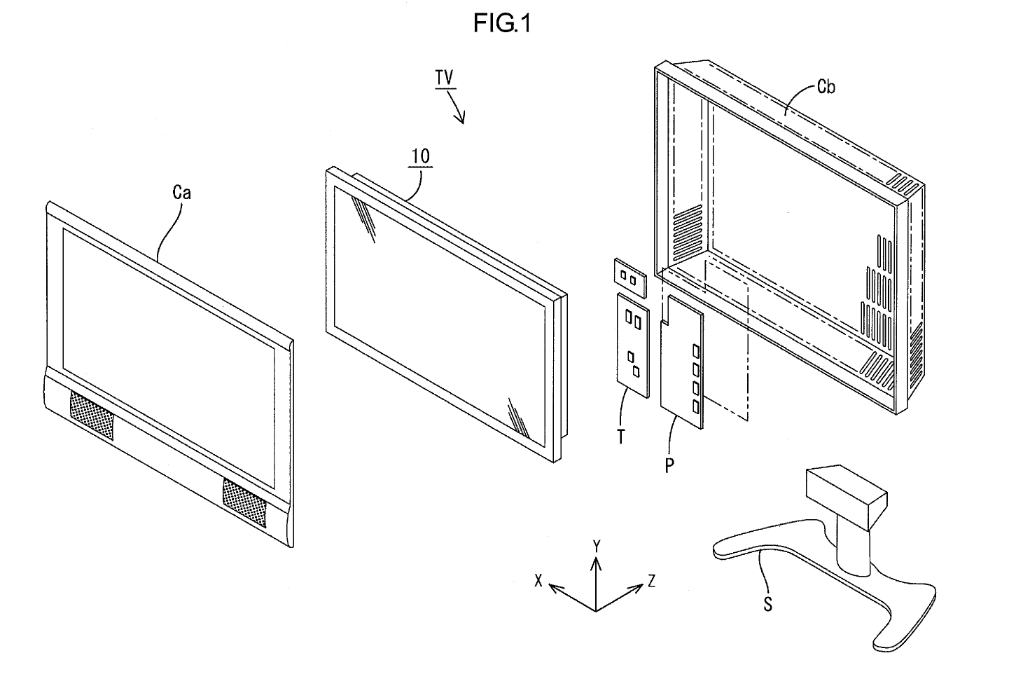

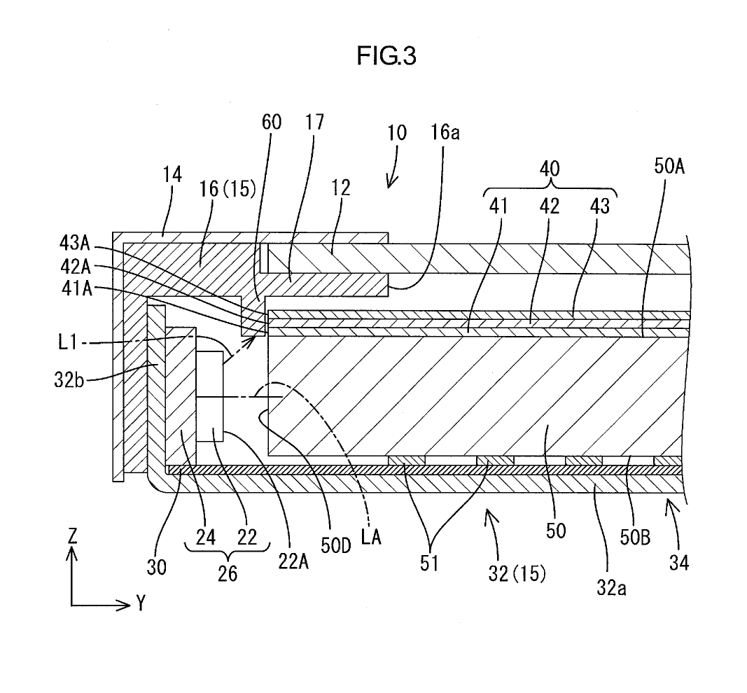

A first embodiment of the present invention will be described with reference to FIGS. 1 to 4. It is to be noted that some figures of the drawings have X, Y or Z axes therein such that the respective axial directions thereof may be directed in a respective same direction in the drawings. And then, the upper side in FIG. 3 is a front side while the lower side therein is a back side.

A television receiver TV according to the present embodiment includes a liquid crystal display device 10, front and back cabinets Ca and Cb housing the liquid crystal display device 10 so as to sandwich the liquid crystal display device 10 between, a power source P, a tuner T and a stand S, as illustrated in FIG. 1.

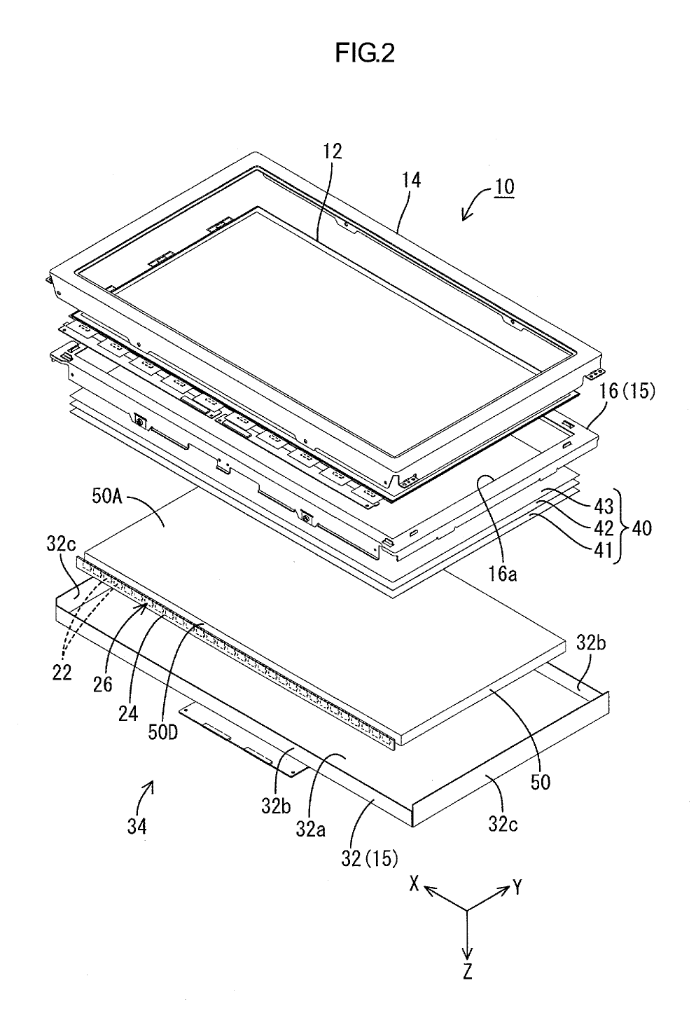

FIG. 2 illustrates an exploded perspective view of the liquid crystal display device 10. It is to be noted that the upper side in FIG. 2 shall is a front side while the lower side shall is a back side. As illustrated in FIG. 2, the liquid crystal display device 10 is formed in a horizontally long rectangular shape as a whole and includes a liquid crystal panel 12 as a display panel and a backlight unit 34 as an external light source such that these two are held integrally by a frame-like bezel 14 or the like.

As illustrated in FIG. 2, the liquid crystal panel 12 constituting the liquid crystal display device 10 is formed in a rectangular shape in a planar view, and a longer side direction thereof corresponds to a horizontal direction (X axial direction) while a shorter side direction thereof corresponds to a vertical direction (Y axial direction). The liquid crystal panel 12 has a configuration in which a pair of transparent glass substrates (i.e., glass substrates of high transmission) is joined together with a predetermined gap between and in which a liquid crystal layer (not shown) is filled with between the glass substrates. One glass substrate has switching components (such as TFTs) connected to source lines and gate lines perpendicular to each other, pixel electrodes connected to the switching components, an alignment film and the like while the other glass substrate has color filters having respective color sections such as R (red), G (green) and B (blue) in a predetermined array, counter electrodes, an alignment film and the like. The source lines, gate lines, counter electrodes and the like are supplied from a not shown drive circuit board with image data and various control signals required for image display. Polarizing plates (not shown) are disposed on external to the glass substrates.

Next, the backlight unit 34 will be described. As illustrated in FIG. 2, the backlight unit 34 includes a housing member 15 constituting of a backlight chassis 32 and a front chassis 16, and the housing member 15 houses therein an LED unit 26, a light guide plate 50 and an optical member 40. The backlight unit 34 according to the present embodiment adopts a so-called edge light type (side light type), in which the light guide plate 50 is arranged directly below the liquid crystal panel 12 and LEDs 22 (Light Emitting Diode as light source) are arranged at a side edge portion of the light guide plate 50.

The backlight chassis 32 is formed approximately in a box shape open to the front side (light outgoing side, i.e., a side of the liquid crystal panel 12). The optical member 40 is arranged to cover the opening portion of the backlight chassis 32. The front chassis 16 is formed in a rectangular frame shape having an opening portion 16a exposing the optical member 40 from the front side and is arranged to surround the optical member 40. An inner circumferential end portion of the front chassis 16 has a step portion 17, on which a peripheral portion of the liquid crystal panel 12 is mounted. This brings a configuration in which light output from the light guide plate 50 passes through the optical member 40 and is thereafter illuminated to a back side of the liquid crystal panel 12 via the opening portion 16a.

The backlight chassis 32 is made of a metal such as an aluminum-based material and includes a bottom plate 32a formed in a rectangular shape in a planar view and side plates 32b and 32c standing up to the front side from respective outer ends of both longer sides and both shorter sides of the bottom plate 32a. As for the bottom plate 32a, a longer side direction thereof corresponds to a horizontal direction (X axial direction) while a shorter side direction thereof corresponds to a vertical direction (Y axial direction). On aback side of the bottom plate 32a is attached a power supply circuit board (not shown) or the like supplying power to the LED unit 26.

The LED unit 26 is attached by screw clamp or the like to an inner surface side of one side plate 32b out of the side plates 32b along the longer side direction (X axial direction) of the backlight chassis 32. The LED unit 26 has a configuration in which the white light-emitting LEDs 22 are arranged linearly on an LED board 24 extending along the X axial direction and formed in a rectangular shape, as illustrated in FIG. 2.

As illustrated in FIG. 3, as for each LED 22, a light axis LA thereof is arranged along a direction parallel to a display surface of the liquid crystal panel 12 or a light exit surface 50A of the light guide plate 50 (Y axial direction), and a light emitting surface 22A thereof faces a side surface (light entrance surface 50D) of the light guide plate 50. Light emitted from the LED 22 spreads three-dimensionally and radially to some extent within a predetermined angular range centering on the light axis LA, and its directivity is higher than that of a cold cathode tube or the like. In other words, a light emitting intensity of the LED 22 represents an angular distribution in which it is inclined to be remarkably high in a direction along the light axis LA and be drastically decreased as a tilt angle from the light axis LA becomes larger.

The LED 22 has a configuration in which a plurality of LED chips as light emitting elements are enclosed in a housing by a resin material or the like. For example, this LED 22 incorporates three kinds of LED chips having different main emission wavelengths, and specifically, each of the LED chips emits monochromatic light of R (red), G (green) or B (blue). The configuration of the LED 22 is not limited to this, but may be another configuration. For example, the LED 22 may have a configuration in which an LED chip that emits monochromatic light of B (blue) is incorporated and is covered with a resin (such as a silicon-based resin) in which a fluorescent body having an emission peak in an area of R (red) and the fluorescent body having the emission peak in an area of G (green) are enclosed. Alternatively, the LED 22 may have a configuration in which an LED chip that emits monochromatic light of B (blue) is incorporated and is covered with the resin (such as the silicon-based resin) in which the fluorescent body emitting yellow light such as a YAG fluorescent body is enclosed.

The LED board 24 is made of a synthetic resin having a white surface (including an opposed surface to the light guide plate 50) excellent in light reflectivity. The LED board 24 is formed in a rectangular plate shape extending in the X axial direction, and a longer side dimension thereof is set to be slightly smaller than (or approximately equal to) a longer side dimension of the bottom plate 32a, as illustrated in FIG. 2. The bottom plate 32a has an attaching hole (not shown) screwing the LED board 24 penetrated at a predetermined position.

The LED board 24 has a wiring pattern (not shown) made of a metal film and implements the plurality of LEDs 22 at predetermined positions. This LED board 24 is connected to a not shown control board, which supplies power required for illumination of the LEDs 22 and is configured to control driving of the LEDs 22.

The light guide plate 50 is a plate-like member formed in a square shape in a planar view and is elongated in the longer side direction (X axial direction) of the backlight chassis 32. The light guide plate 50 is made of a highly light transmissive (highly transparent) resin such as acrylic. As for the light guide plate 50, as shown in FIG. 2, a main plate surface (light exit surface 50A) thereof faces the liquid crystal panel 12 while one surface (light entrance surface 50D) out of side surfaces thereof is arranged to be opposed to the light emitting surfaces 22A of the LEDs 22. It is to be noted that the shape of the light guide plate 50 is not limited the square shape in a planar view but may be another shape.

In the light guide plate 50, a surface 50B on the opposite side of the light exit surface 50A (hereinafter, back side surface 50B) has a plurality of light reflecting portions 51. For example, the light reflecting portions 51 are configured to have a white dot pattern and function to scatter light by reflection. Accordingly, some light scattered by reflection at the light reflecting portions 51 and heading toward the light exit surface 50A becomes light whose incident angle to the light exit surface 50A does not exceed a critical angle (light without total reflection), and thus the configuration is obtained that light is output from the light exit surface 50A to the side of the liquid crystal panel 12. For example, the light reflecting portions 51 have a configuration in which a plurality of dots formed in round shapes in planar views are arranged in a zigzag manner (in a hound's-tooth manner or in an alternate manner). For example, each dot is formed by printing metal-oxide-containing paste on the back side surface 50B of the light guide plate 50. A preferable printing method for this includes screen printing, ink jet printing or the like.

In the above configuration, light emitted from the light emitting surfaces 22A of the respective LEDs 22 makes incidence into the light guide plate 50 from the light entrance surface 50D of the light guide plate 50, is thereafter guided in the light guide plate 50 by total reflection, is scattered by reflection at the light reflecting portions 51 and is output from the light exit surface 50A. The light output from the light exit surface 50A passes through the optical member 40 and is thereafter output to a back surface side of the liquid crystal panel 12. Meanwhile, the respective light reflecting portions 51 are, e.g., in a range corresponding to the aforementioned opening portion 16a of the front chassis 16 (a range overlapped with the opening portion 16a in a planar view).

Also, on the bottom plate 32a of the backlight chassis 32 is laid down on a light reflecting sheet 30. The light reflecting sheet 30 is formed in a square shape in a planar view and is arranged to cover approximately an entire area of the back side surface 50B of the light guide plate 50 and the LED unit 26 from the back side. The light reflecting sheet 30 is made, e.g., of a synthetic resin and has a white surface of high light reflectivity. This light reflecting sheet 30 is configured to reflect the light output from the light guide plate 50 to the side of the light reflecting sheet 30, to the side of the light exit surface 50A again, which contributes to improvement in light use efficiency. The light reflecting sheet 30 also functions to reflect light output from the LEDs 22 to the side of the light reflecting sheet 30 to make incidence of the light into the light entrance surface 50D of the light guide plate 50. It is to be noted that the material, color and the like of the light reflecting sheet 30 are not limited to those in the present embodiment, and the light reflecting sheet 30 has only to have a function to reflect light.

The optical member 40 is arranged to cover the light exit surface 50A of the light guide plate 50 from the front side and has a light diffuser sheet 41 (light diffuser member), a prism sheet 42 and a reflection type polarizing sheet 43 laminated in this order from the side of the light exit surface 50A. The light diffuser sheet 41 is made, e.g., by joining a diffuser layer in which light scattering particles are dispersed to a surface of a synthetic-resin-made light transmissive base substrate and functions to diffuse light output from the light exit surface 50A. The prism sheet 42 functions to adjust a traveling direction of light passing through the light diffuser sheet 41.

The reflection type polarizing sheet 43 has a multilayered structure in which layers having respective different refractive indices are laminated alternately and is configured to let p waves of the light output from the light exit surface 50A transmitted and s waves thereof reflected to the side of the light guide plate 50. The s wave reflected by the reflection type polarizing sheet 43 is reflected to the front side again by the light reflecting sheet 30 or the like and is separated into the s wave and the p wave at this time. In this manner, providing the reflection type polarizing sheet 43 enables reusing of s waves, which are supposed to be absorbed in the polarizing plates of the liquid crystal panel 12, which contributes to improvement in light use efficiency (and brightness). An example of such a reflection type polarizing sheet 43 is a product named “DBEF” manufactured by Sumitomo 3M Limited.

As illustrated in FIG. 2, the light diffuser sheet 41, the prism sheet 42 and the reflection type polarizing sheet 43 are formed in square shapes elongated in the X axial direction in planar views, similar to that of the light guide plate 50. Each of the light diffuser sheet 41, the prism sheet 42 and the reflection type polarizing sheet 43 is set to have an approximately equal area to that of the light exit surface 50A of the light guide plate 50, and is configured to cover an entire surface of the light exit surface 50A of the light guide plate 50 from the front side. It is to be noted that the shape of each of the sheets 41 to 43 constituting the optical member 40 is not limited to the square shape in a planar view and may be another shape as long as each sheet is configured to cover at least a part of the light exit surface 50A of the light guide plate 50 from the front side.

The front chassis 16 has a light blocking portion 60 around a base edge portion of the step portion 17. The light blocking portion 60 is formed by projecting a part of the front chassis 16 (that is, a part of the housing member 15) to the back side thereof and is arranged at an edge portion of the optical member 40 on the side of the LEDs 22 (an edge portion on the left side in FIG. 3).

The light blocking portion 60 is elongated in the X axial direction, and its length is set to be equal, e.g., to one of the optical member 40 in the X axial direction. Also, in the Y axial direction, a projecting edge of the light blocking portion 60 to the back side (lower edge in FIG. 3) is located, e.g., at an approximately equal position to that of the back side surface of the light diffuser sheet 41. Accordingly, the light blocking portion 60 is configured to be arranged to cover respective side surfaces 41A to 43A on the side of the LEDs 22 (side surface of the optical member on the light source side) of the light diffuser sheet 41, the prism sheet 42 and the reflection type polarizing sheet 43 constituting the optical member 40, and functions to block light incident from the respective side surfaces 41A to 43A of the optical member 40 on the side of the LEDs 22 into the respective sheets 41 to 43. It is to be noted that the light blocking portion 60 may be configured to cover only a part of the respective side surfaces 41A to 43A of the optical member 40 on the side of the LEDs 22.

The front chassis 16 has a black surface excellent in light absorbance. Accordingly, the light blocking portion 60 as a part of the front chassis 16 is black and is a light absorbing portion configured to absorb light. It is to be noted that the configuration of the front chassis 16 is not limited to one in which the entire front chassis 16 is set to be black, but only the light blocking portion 60 may be colored in black as a light absorbing portion.

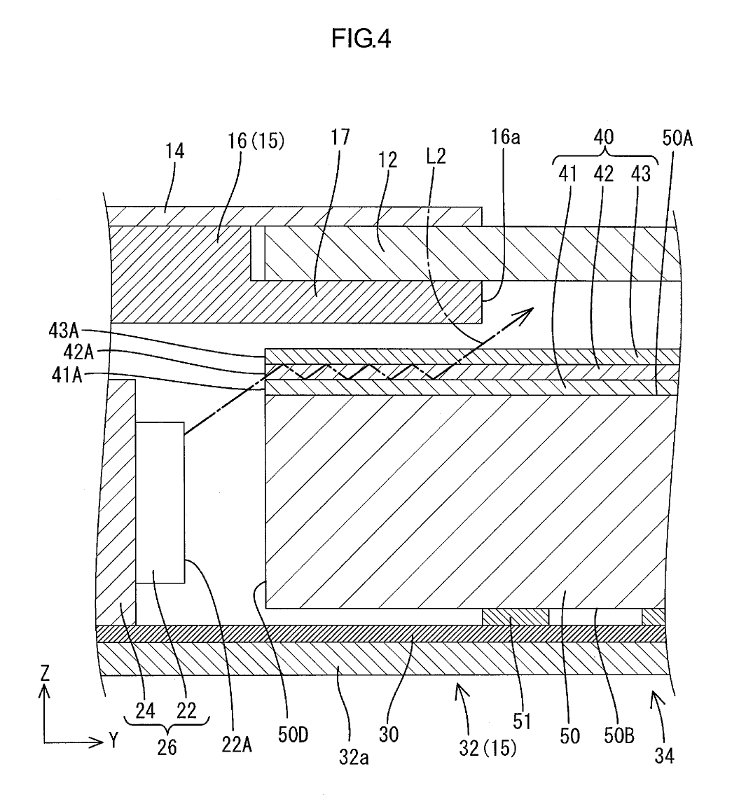

Next, effects of the present embodiment will be described. First, an effect caused by forming the light blocking portion 60 at the edge portion of the light exit surface 50A on the side of the LEDs 22 will be described with reference to FIGS. 3 and 4. FIG. 4 illustrates a comparative example describing this effect and without the light blocking portion 60.

In the configuration illustrated in FIG. 4, there is a case in which a part of light output from the LEDs 22 (indicated as an arrow L2 in FIG. 4) reaches a front side of the light entrance surface 50D and makes incidence into the optical member 40 from the respective side surfaces 41A to 43A of the optical member 40. Here, a case in which light L2 makes incidence into the side surface 42A of the prism sheet 42 in the optical member 40 on the side of the LEDs 22 will be described as an example.

The light L2 incident from the side surface 42A of the prism sheet 42 on the side of the LEDs 22 repeats total reflection in the prism sheet 42 and is guided to an inside of the backlight unit 34 (right side in FIG. 4). Subsequently, the light L2 guided to the inside may be output to the front side from a location corresponding to the opening portion 16a of the front chassis 16 (inside area of the front chassis 16) in the prism sheet 42. Thus, in the light exit surface of the backlight unit 34 (area corresponding to the opening portion 16a of the front chassis 16 in a planar view), a location at which the light L2 has been output has higher brightness than the other locations and is liable to cause uneven brightness.

Although the case in which the light L2 makes incidence from the side surface 42A of the prism sheet 42 has been described herein as an example, a similar phenomenon (a phenomenon in which light is guided in each sheet and is output locally) may occur also in a case where light makes incidence from the side surface 41A or 43A of the light diffuser sheet 41 or the reflection type polarizing sheet 43. Meanwhile, when the prism sheet 42 and the light diffuser sheet 41 are compared, light guided in the prism sheet 42 is more liable to cause uneven brightness. The reason for this is that light guided in the light diffuser sheet 41 is diffused in the light diffuser sheet 41 and is thus not liable to cause uneven brightness even in a case of being output to the front side.

To deal with such circumstances, the backlight unit 34 of the present embodiment is configured to arrange the light blocking portion 60 so as to cover the respective side surfaces 41A to 43A of the optical member 40. In this configuration, light heading toward the respective side surfaces 41A to 43A of the optical member 40 from the LEDs 22 is blocked by the light blocking portion 60 (light is absorbed in the present embodiment). This restricts the phenomenon in which light makes incidence into the respective sheets 41 to 43 constituting the optical member 40 and is guided in the respective sheets 41 to 43. This restricts the phenomenon in which light guided in the respective sheets 41 to 43 is output locally at the light exit surface of the backlight unit 34 and restricts occurrence of uneven brightness.

Also, the housing member 15 housing the LEDs 22, light guide plate 50 and optical member 40 is provided, the light blocking portion 60 is formed by projecting a part of the housing member 15 and is arranged to cover the side surfaces 41A to 43A of the optical member 40 on the side of the LEDs 22. Forming the light blocking portion 60 by projecting a part of the housing member 15 dispenses with separate attachment of the light blocking portion 60 and reduces cost for assembly.

Further, the light blocking portion 60 is a light absorbing portion configured to absorb light. In this configuration, light incident from the side surfaces 41A to 43A of the optical member 40 on the side of the LEDs 22 into the respective sheets 41 to 43 is absorbed by the light blocking portion 60, which restricts incidence of light into the optical member 40 more reliably.

### Second Embodiment

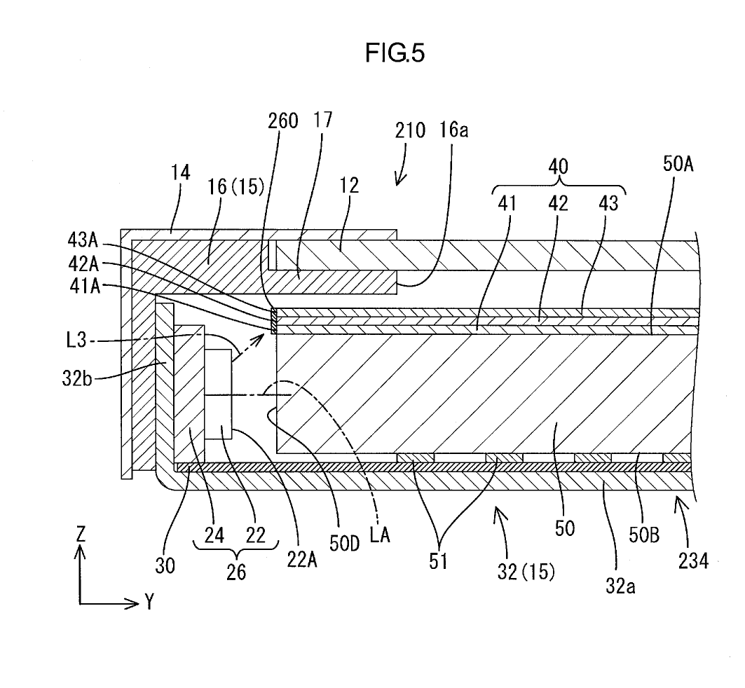

Next, a second embodiment of the present invention will be described with reference to FIG. 5. Identical components to those in the first embodiment are shown with the identical symbols, and description of the duplicate components is omitted. As illustrated in FIG. 5, in a backlight unit 234 of a liquid crystal display device 210 according to the present embodiment, a light blocking portion 260 is formed by applying paint having a color excellent in light absorbance (such as black) to the respective side surfaces 41A to 43A of the optical member 40 on the side of the LEDs 22.

In this configuration, light heading toward the respective side surfaces 41A to 43A of the respective sheets 41 to 43 on the side of the LEDs 22 is absorbed by the light blocking portion 260 and restricted to make incidence of the light into the respective sheets 41 to 43. It is to be noted that the light blocking portion 260 may be formed by applying the paint to entirely over the respective side surfaces 41A to 43A of the optical member 40 on the side of the LEDs 22 or only on a part of the respective side surfaces 41A to 43A.

The light blocking portion 260 may be a light reflecting portion that reflects light. Specifically, the light blocking portion 260 may be configured by applying paint having a function to reflect light (such as white paint) to the respective side surfaces 41A to 43A of the optical member 40 on the side of the LEDs 22. Also, the light blocking portion 260 may additionally have a function to scatter light by adding metal oxide or the like into the paint. That is, the light blocking portion 260 has only to have light blocking properties. The configuration of forming the light blocking portion 260 by applying the paint as in the present embodiment further reduces a size of the light blocking portion 260 and restricts a size increase of the backlight unit 234.

### Third Embodiment

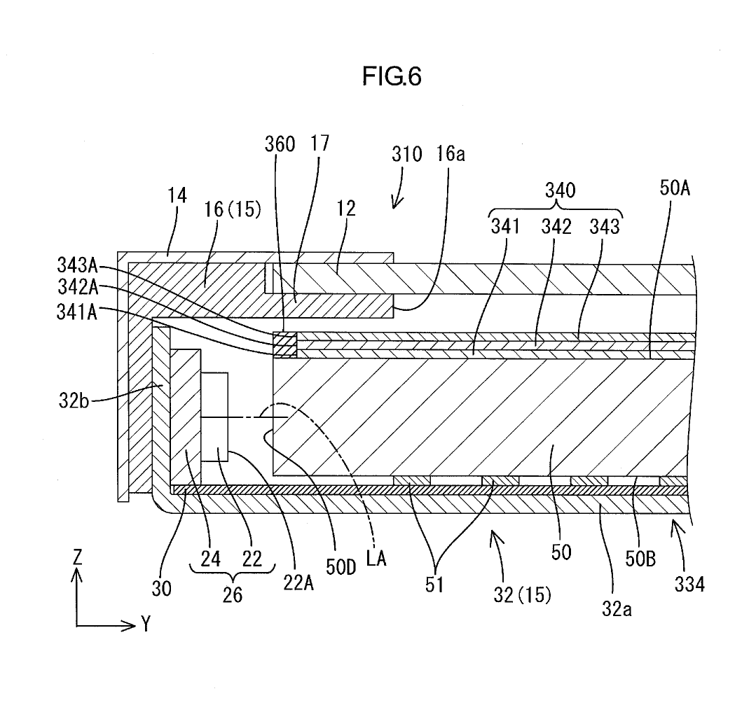

Next, a third embodiment of the present invention will be described with reference to FIG. 6. Identical components to those in each of the above embodiments are shown with the identical symbols, and description of the duplicate components is omitted. A backlight unit 334 of a liquid crystal display device 310 according to the present embodiment uses a light reflecting sheet (light reflecting portion) as a light blocking portion 360. The light reflecting sheet used as the light blocking portion 360 is made, e.g., of a synthetic resin and has a white surface excellent in light reflectivity. It is to be noted that the configuration of the light reflecting sheet is not limited to this but has only to have a function to reflect light.

In the present embodiment, the light blocking portion 360 (light reflecting sheet) is in an elongated shape extending in the X axial direction (the arranged direction of the respective LEDs 22). As illustrated in FIG. 6, in the present embodiment, the length of an optical member 340 (a light diffuser sheet 341, a prism sheet 342 and a reflection type polarizing sheet 343 constituting the optical member 340) in the Y axial direction is set to be shorter than the length of the light guide plate 50 in the same direction. Thus, the light exit surface 50A of the light guide plate 50 has at a circumferential edge portion on the side of the LEDs 22 an area without the optical member 340. The light blocking portion 360 is mounted at this area without the optical member 340 to cover respective side surfaces 341A to 343A of respective sheets 41 to 43 on the side of the LEDs 22. In this configuration, light from the LEDs 22 is reflected by the light blocking portion 360, which thus restricts incidence of light from the respective side surfaces 341A to 343A of the respective sheets 341 to 343 on the side of the LEDs 22.

Also, instead of the light reflecting sheet, a light absorbing sheet (light absorbing portion) may be used as the light blocking portion 360. Such a light absorbing sheet is configured by coloring a surface of a PET-resin plate member in black excellent in light absorbance. It is to be noted that the configuration of the light absorbing sheet is not limited to this configuration and has only to be one having a function to absorb light.

### Other Embodiment

The present invention is not limited to the above embodiments explained in the above description. The following embodiments may be included in the technical scope of the present invention, for example.

(1) The configurations of the light blocking portions 60, 260 and 360 are not limited to ones in the above respective embodiments and have only to be ones of blocking light incident from the side surfaces 41A to 43A of the respective sheets 41 to 43 into the respective sheets 41 to 43. For example, a light blocking portion may be formed by enclosing light blocking members (such as particles of a resin colored in black and having a light absorbing effect) into the edge portions of the respective sheets 41 to 43 of the optical member 40 on the side of the LEDs 22. That is, the light blocking portion may be arranged inside the optical member 40. This configuration dispenses with separate attachment of the light blocking portion and reduces cost for assembly.

(2) Although each of the light blocking portions 60, 260 and 360 is configured to cover the respective side surfaces 41A to 43A (341A to 343A) of the respective sheets 41 to 43 (341 to 343) constituting the optical member 40 or 340 in the above respective embodiments, it may be configured to cover only the side surface of any of the three sheets 41 to 43 (341 to 343).

(3) Although the light blocking portion 60 is a part of the front chassis 16 in the above first embodiment, the present invention is not limited to this configuration. For example, the light blocking portion may be a separate body, and an attaching location and a shape thereof can be altered as needed. For example, the light blocking portion 60 may be attached to the LED board 24, and be formed in a manner of projecting toward the light guide plate 50 from the LED board 24 so as to cover the respective side surfaces 41A to 43A of the respective sheets 41 to 43.

(4) The configurations of the optical members 40 and 340 are not limited to ones illustrated in the above embodiments. Whether or not the respective sheets constituting each of the optical members 40 and 340 are provided and a number of sheets used can be altered as needed. For example, each of the optical members 40 and 340 may have only the light diffuser sheet 41. Also, each of the optical members 40 and 340 may have members other than those illustrated in the above embodiments, such as a diffuser plate (light diffuser member) and a lens sheet that have a light blocking portion at edge portions thereof on the side of the LEDs 22. In other words, in the present invention, any optical member can be applied as long as it can guide light inside, and the configuration has only to have a light blocking portion at an edge portion of the optical member on the side of the LEDs 22.

(5) Although the configuration in which the LED unit 26 is arranged only at one plate out of the side plates 32b and 32c of the backlight chassis 32 has been illustrated in the above respective embodiments, the present invention is not limited to this configuration. The LED units 26 may be configured to be arranged at plural plates such as the other plates 32b and 32c. In a case of this configuration, light blocking portions can be configured to be arranged at edge portions of the optical member 40 on the sides of the respective LED units 26 (LEDs 22), respectively.

(6) The backlight chassis 32 and the front chassis 16 constituting the housing member 15 may be an integrated part.

(7) Although the LED 22 (Light Emitting Diode) has been illustrated as a light source in the above embodiments, the light source is not limited to this, and a light source other than the LED can be applied.

(8) Although the TFT has been used as a switching component of the liquid crystal display device in the above embodiments, the present invention can be applied to a liquid crystal display device using a switching component other than the TFT (such as a thin-film diode (TFD)) and can be applied to a monochrome liquid crystal display device as well as a color liquid crystal display device.

(9) Although the liquid crystal display device using a liquid crystal panel as a display panel has been illustrated in the above embodiments, the present invention can be applied to a display device using another kind of display panel.

(10) Although the television receiver having a tuner has been illustrated in the above embodiments, the present invention can be applied to a display device without a tuner.

### EXPLANATION OF SYMBOLS

10, 210, 310: Liquid crystal display device (Display device)

12: Liquid crystal panel (Display panel)

15: Housing member

22: LED (Light source)

22A: Light emitting surface

34, 234, 334: Backlight unit (Lighting device)

41, 341: Light diffuser sheet (Optical member, Light diffuser member)

41A, 341A: Side surface of the light diffuser sheet (Side surface of the optical member on the light source side)

42, 342: Prism sheet (Optical member)

42A, 342A: Side surface of the prism sheet (Side surface of the optical member on the light source side)

43, 343: Reflection type polarizing sheet (Optical member)

43A, 343A: Side surface of the reflection type polarizing sheet (Side surface of the optical member on the light source side)

50: Light guide plate

50A: Light exit surface

50D: Light entrance surface

60, 260, 360: Light blocking portion

TV: Television receiver

1. A lighting device comprising:
a light source having a light emitting surface;
a light guide plate arranged opposite to the light emitting surface and having a light entrance surface through which light from the light emitting surface enters and a light exit surface from which the light is output; and
an optical member arranged to cover the light exit surface, the optical member having a light blocking portion at an edge portion thereof on a light source side and being configured to block light entering the optical member from a side surface of the optical member on the light source side.

2. The lighting device according to claim 1, further comprising a housing member housing the light source, the light guide plate and the optical member,
wherein the light blocking portion is formed by projecting a part of the housing member and is arranged to cover the side surface of the optical member on the light source side.

3. The lighting device according to claim 1, wherein the light blocking portion is formed by applying paint having light blocking properties to the side surface of the optical member on of the light source side.

4. The lighting device according to claim 1, wherein the light blocking portion is formed by enclosing a light blocking member into the edge portion of the optical member on the light source side.

5. The lighting device according to claim 1, wherein the light blocking portion is a light absorbing portion configured to absorb light.

6. The lighting device according to claim 1, wherein the light blocking portion is a light reflecting portion configured to reflect light.

7. The lighting device according to claim 1, wherein the optical member includes a light diffuser member.

8. The lighting device according to claim 1, wherein the optical member includes a prism sheet.

9. The lighting device according to claim 1, wherein the optical member includes a reflection-type polarizing sheet.

10. The lighting device according to claim 1, wherein the light source is a light emitting diode.

11. A display device comprising:
the lighting device according to claim 1; and
a display panel configured to provide display utilizing light from the lighting device.

12. The display device according to claim 11, wherein the display panel is a liquid crystal panel including liquid crystals.

13. A television receiver comprising the display device according to claim 11.
